(19) United States
(12) Patent Application Publication
(10) Pub. No.: US 2024/0147597 A1
(43) Pub. Date: May 2, 2024

(54) LIGHT SYSTEM, LIGHT ELEMENT, AND MOUNTING PAD OF LIGHT

(71) Applicant: SAVANT TECHNOLOGIES LLC, East Cleveland, OH (US)

(72) Inventors: Hongbin XU, Shanghai (CN); Aijun WANG, Shanghai (CN); Zhiyong WANG, Shanghai (CN); JinPeng HU, Shanghai (CN); Liang SHAN, Beijing (CN); Jing CHEN, Shanghai (CN)

(73) Assignee: SAVANT TECHNOLOGIES LLC, East Cleveland, OH (US)

(21) Appl. No.: 18/463,958

(22) Filed: Sep. 8, 2023

(30) Foreign Application Priority Data
Sep. 9, 2022 (CN) 202211103016.6

(51) Int. Cl. H05B 47/19; F21S 9/02; F21V 21/08; F21V 21/096; F21V 23/00; H05B 47/105; H05B 47/155; H05B 47/17; H05B 47/175

(52) U.S. Cl. CPC H05B 47/19; F21S 9/02; F21V 21/0808; F21V 21/096; F21V 23/009; H05B 47/105; H05B 47/155; H05B 47/17; H05B 47/196

(57) ABSTRACT

Provided is a light system, a light element, and a mounting pad of a light. The light system includes a light element and a mounting pad. The light element includes a light-emitting unit to emit light; an attachment unit to attach the light element to any position on a mounting surface on which the light element is mounted; a wireless electric-power receiving unit to receive electric power for driving the light element by wireless electric-power transmission; and a light-emitting unit power supply circuit, connected to the wireless electric-power receiving unit to transmit the electric power received by the wireless electric-power receiving unit to the light-emitting unit. The mounting pad includes a mounting area having the mounting surface on which the light element is mounted and a wireless electric-power transmitting unit to transmit the electric power to the wireless electric-power receiving unit on the mounting surface by wireless electric-power transmission.

### CROSS-REFERENCE TO RELATED APPLICATIONS

This application claims the benefit of Chinese Patent Application Serial Number 202211103016.6, filed Sep. 9, 2022, which is incorporated herein by reference.

### FIELD OF TECHNOLOGY

This application relates to the field of lighting control. Specifically, this application relates to a light system, a light element, and a mounting pad of a light.

### BACKGROUND

An existing light is connected to a power supply by means of a plug and a cable, so as to provide electric power for emitting light for the light devices.

If it is required to provide a light that emits light with a specific pattern, a light-emitting unit of the pattern is required to be manufactured separately, and overall mounting and control are performed on the light-emitting unit.

The light is also designed to include a plurality of strip light tubes. The plurality of strip light tubes is connected to each other by using connectors so as to form the specific pattern. The connected light tubes are pasted on a mounting pad by using a tape. In order to supply power to such a light, a cable and a plug that are connected to the light tubes are required to be additionally disposed, and then the plug is plugged in a power supply interface to supply power to the light by means of the cable. If it is about to control a light-emitting mode of the light, it is required to serially connect a controller and a processor on the cable. The controller is operated to control the processor to send a specific control command to the light, so as to control the light-emitting mode of the light.

However, connecting the plurality of light tubes by means of the connector has the problems that a connection mode is tedious, and the patterns formed are less and not free enough. Using the cable to supply power to the light further limits the flexibility of mounting the light. Controlling the light-emitting mode by using the controller connected to the cable requires access to the light, limiting the flexibility of controlling the light.

### SUMMARY

Embodiments of this application provide a light system, a light element, and a mounting pad of a light, to at least resolve low flexibility of mounting and controlling the light in the prior art.

An aspect of an embodiment of this application provides a light system, including at least one light element and a mounting pad. The light element includes: a light-emitting unit, configured to emit light; an attachment unit, configured to attach the light element to any position on a mounting surface on which the light element is mounted; a wireless electric-power receiving unit, configured to receive electric power for driving the light element on the mounting surface by means of wireless electric-power transmission; and a light-emitting unit power supply circuit, connected to the wireless electric-power receiving unit and the light-emitting unit and configured to transmit the electric power received by the wireless electric-power receiving unit to the light-emitting unit. The mounting pad includes: a mounting area, provided with the mounting surface on which the light element is mounted; and a wireless electric-power transmitting unit, configured to transmit the electric power to the wireless electric-power receiving unit of the light element on the mounting surface by means of wireless electric-power transmission.

In this way, a mounting method of the light element is flexible, and a power supply method is not affected by a cable.

According to an exemplary embodiment of this application, at least one light element is mounted on the mounting surface so as to form characters or patterns.

In this way, the light can emit light in the form of characters or patterns.

According to an exemplary embodiment of this application, the light element further includes a light-emitting control unit. The light-emitting control unit is configured to control the light-emitting unit to emit light according to a light-emitting control signal for controlling a light-emitting mode of the light-emitting unit.

In this way, the light element can be controlled to emit the light required.

According to an exemplary embodiment of this application, the light-emitting control unit is configured to generate the light-emitting control signal for controlling the light-emitting mode of the light-emitting unit.

In this way, the light element can automatically control its own light-emitting mode.

According to an exemplary embodiment of this application, the light element further includes: a wireless communication unit, configured to receive the light-emitting control signal by means of wireless communication, and transmit the light-emitting control signal to the light-emitting control unit. The mounting pad further includes: a wireless control unit, configured to transmit the light-emitting control signal to the wireless communication unit of the light element by means of wireless communication.

In this way, the light element can emit light in a wirelessly controlled manner through the mounting pad.

According to an exemplary embodiment of this application, each light element further includes: a light element information unit, configured to transmit identification information data uniquely identifying the light element and wireless address data of the light element by means of the wireless communication unit. The mounting pad further includes: a light element addressing unit, configured to receive the identification information data of the light element and the wireless address data of the light element from the wireless communication unit, so as to perform addressing on the light element.

In this way, each light element can be uniquely identified, and can be accessed during wireless control, so that the independent and specific control of the light element can be achieved.

According to an exemplary embodiment of this application, that the wireless control unit is configured to transmit the light-emitting control signal to the wireless communication unit of the light element by means of wireless communication includes: according to a result that addressing is performed on the light element, transmitting each of the at least one light-emitting control signal to a wireless communication unit of the corresponding light element in the at least one light element.

In this way, in combination with the addressing result, the corresponding light-emitting control signal is transmitted to the corresponding light element, so as to cause each light element to be correctly controlled to emit light.

According to an exemplary embodiment of this application, the operation of performing addressing on the light element further includes determining position information of each of the at least one light element on the mounting surface of the mounting area of the mounting pad. The operation of transmitting each of the at least one light-emitting control signal to the corresponding light element in the at least one light element further includes determining a correspondence between the light element and the light-emitting control signal according to the characters or patterns of the at least one light element formed on the mounting surface and the position information of each light element.

In this way, which light element should emit what light can be determined according to the characters or patterns of the light element on the mounting surface, so that the at least one light element can achieve a light effect of correctly emitting the characters or patterns.

According to an exemplary embodiment of this application, the mounting pad further includes: a light-emitting control signal generation unit, configured to generate the light-emitting control signal for controlling the light-emitting mode of the light-emitting unit, and transmit the light-emitting control signal to the wireless control unit.

In this way, the mounting pad can be configured to control the light-emitting mode of the light element.

According to an exemplary embodiment of this application, the mounting pad further includes: a command acquisition unit, configured to acquire a command used for generating the light-emitting control signal, and transmit the command to the light-emitting control signal generation unit. The light-emitting control signal generation unit generates the light-emitting control signal according to the command.

In this way, the mounting pad can control the light-emitting mode of the light element according to the specific command.

According to an exemplary embodiment of this application, the command acquisition unit includes: an intelligent device communication unit, configured to acquire the command used for generating the light-emitting control signal from an intelligent device. The command comprises data representing selection of the light-emitting mode for the at least one light element.

In this way, the intelligent device can be used to control the light-emitting mode of the light element.

According to an exemplary embodiment of this application, the command acquisition unit includes: a sensor, configured to acquire sensing data obtained by sensing environment information, where the environment information includes at least one of light, temperature, or sound; a feature extraction unit, configured to acquire the sensing data and extract feature data of the environment information; and a command generation unit, configured to acquire the command used for generating the light-emitting control signal according to the feature data. The command includes data representing a correspondence between the feature data and the light-emitting mode of the at least one light element.

In this way, the mounting pad can control the light-emitting mode of the light element according to an external environment.

According to an exemplary embodiment of this application, the attachment unit includes at least one of a magnetic apparatus or a double-sided tape.

In this way, the light element can be easily attached to the mounting pad.

According to an exemplary embodiment of this application, the wireless electric-power transmitting unit of the mounting pad includes at least one wireless electric-power transmitting main coil disposed in the mounting area. The wireless electric-power receiving unit of the light element includes at least one wireless electric-power receiving secondary coil.

In this way, wireless electric-power transmission between the light element and the mounting pad can be achieved.

According to an exemplary embodiment of this application, the mounting pad includes: an alternating-current receiving unit, configured to receive an alternating current; and an AC-DC conversion unit, configured to convert the alternating current received by the alternating-current receiving unit into a direct current, and transmit the direct current to the wireless electric-power transmitting unit.

In this way, the mounting pad can convert alternating-current input electric power into the electric power required for driving the light element.

According to an exemplary embodiment of this application, the light-emitting unit has at least one of the following a plurality of light-emitting modes: emitting light with a single color; emitting light with a plurality of colors; and emitting light with changeable colors.

In this way, the light element can emit the light with specific patterns and colors.

According to an exemplary embodiment of this application, the wireless communication mode includes any one of WIFI, Bluetooth, 5G, and private wireless communication protocols.

In this way, wireless communication between the light element and the mounting pad

can be achieved.

Another aspect of an embodiment of this application further provides a light element, including: a light-emitting unit, configured to emit light; an attachment unit, configured to attach the light element to any position on a mounting surface on which the light element is mounted; a wireless electric-power receiving unit, configured to receive electric power for driving the light element by means of wireless electric-power transmission; and a light-emitting unit power supply circuit, connected to the wireless electric-power receiving unit and the light-emitting unit and configured to transmit the electric power received by the wireless electric-power receiving unit to the light-emitting unit.

In this way, a mounting method of the light element is flexible, and a power supply method is not affected by a cable.

According to an exemplary embodiment of this application, at least one light element is mounted on the mounting surface so as to form characters or patterns.

In this way, the light can emit light in the form of characters or patterns.

According to an exemplary embodiment of this application, the light element further includes a light-emitting control unit. The light-emitting control unit is configured to control the light-emitting unit to emit light according to a light-emitting control signal for controlling a light-emitting mode of the light-emitting unit.

In this way, the light element can be controlled to emit the light required.

According to an exemplary embodiment of this application, the light-emitting control unit is configured to generate the light-emitting control signal for controlling the light-emitting mode of the light-emitting unit.

In this way, the light element can automatically control its own light-emitting mode.

According to an exemplary embodiment of this application, the light element further includes: a wireless communication unit, configured to receive the light-emitting control signal by means of wireless communication, and transmit the light-emitting control signal to the light-emitting control unit.

In this way, the light element can emit light in a wirelessly controlled manner.

According to an exemplary embodiment of this application, each light element further includes: a light element information unit, configured to transmit identification information data uniquely identifying the light element and wireless address data of the light element by means of the wireless communication unit.

In this way, each light element can be uniquely identified, and can be accessed during wireless control, so that the independent and specific control of the light element can be achieved.

According to an exemplary embodiment of this application, the attachment unit includes at least one of a magnetic apparatus or a double-sided tape.

In this way, the light element can be easily attached to a mounting position.

According to an exemplary embodiment of this application, the wireless electric-power receiving unit of the light element includes at least one wireless electric-power receiving secondary coil.

In this way, wireless electric-power receiving of the light element can be achieved.

According to an exemplary embodiment of this application, the light element further includes an electric-power storage unit, disposed between the wireless electric-power receiving unit and the light-emitting unit power supply circuit, and configured to store the electric power received by the wireless electric-power receiving unit and transmit the electric power to the light-emitting unit power supply circuit.

In this way, the light element can store the electric power, so as to emit light when not being powered externally.

According to an exemplary embodiment of this application, the light-emitting unit has at least one of the following a plurality of light-emitting modes: emitting light with a single color; emitting light with a plurality of colors; and emitting light with changeable colors.

In this way, the light element can emit the light with specific patterns and colors.

According to an exemplary embodiment of this application, the wireless communication mode includes any one of WIFI, Bluetooth, 5G, and private wireless communication protocols.

In this way, wireless communication of the light element can be achieved.

Another aspect of an embodiment of this application further provides a mounting pad of a light, including: a mounting area, provided with a mounting surface on which a light element is mounted; and a wireless electric-power transmitting unit, configured to transmit electric power to the light element on the mounting surface by means of wireless electric-power transmission.

In this way, a mounting method of the light element is flexible, and a power supply method is not affected by a cable.

According to an exemplary embodiment of this application, the mounting pad further includes: a wireless control unit, configured to transmit a light-emitting control signal for controlling a light-emitting mode to the light element by means of wireless communication.

In this way, the light element can emit light in a wirelessly controlled manner through the mounting pad.

According to an exemplary embodiment of this application, the mounting pad further includes: a light element addressing unit, configured to receive identification information data of the light element and wireless address data of the light element from the light element, so as to perform addressing on the light element.

In this way, each light element can be uniquely identified, and can be accessed during wireless control, so that the independent and specific control of the light element can be achieved.

According to an exemplary embodiment of this application, that the wireless control unit is configured to transmit the light-emitting control signal to the wireless communication unit of the light element by means of wireless communication includes: according to a result that addressing is performed on the light element, transmitting each of the at least one light-emitting control signal to a wireless communication unit of the corresponding light element in the at least one light element.

In this way, in combination with the addressing result, the corresponding light-emitting control signal is transmitted to the corresponding light element, so as to cause each light element to be correctly controlled to emit light.

According to an exemplary embodiment of this application, the operation of performing addressing on the light element further includes determining position information of each of the at least one light element on the mounting surface of the mounting area of the mounting pad. The operation of transmitting each of the at least one light-emitting control signal to the corresponding light element in the at least one light element further includes determining a correspondence between the light element and the light-emitting control signal according to the characters or patterns of the at least one light element formed on the mounting surface and the position information of each light element.

In this way, which light element should emit what light can be determined according to the characters or patterns of the light element on the mounting surface, so that the at least one light element can achieve a light effect of correctly emitting the characters or patterns.

According to an exemplary embodiment of this application, the mounting pad further includes: a light-emitting control signal generation unit, configured to generate the light-emitting control signal for controlling the light-emitting mode of the light element, and transmit the light-emitting control signal to the wireless control unit.

In this way, the mounting pad can be configured to control the light-emitting mode of the light element.

According to an exemplary embodiment of this application, the mounting pad further includes: a command acquisition unit, configured to acquire a command used for generating the light-emitting control signal, and transmit the command to the light-emitting control signal generation unit. The light-emitting control signal generation unit generates the light-emitting control signal according to the command.

In this way, the mounting pad can control the light-emitting mode of the light element according to the specific command.

According to an exemplary embodiment of this application, the command acquisition unit includes: an intelligent device communication unit, configured to acquire the command used for generating the light-emitting control signal from an intelligent device. The command comprises data representing selection of the light-emitting mode for the at least one light element.

In this way, the intelligent device can be used to control the light-emitting mode of the light element.

According to an exemplary embodiment of this application, the command acquisition unit includes: a sensor, configured to acquire sensing data obtained by sensing environment information, where the environment information includes at least one of light, temperature, or sound; a feature extraction unit, configured to acquire the sensing data and extract feature data of the environment information; and a command generation unit, configured to acquire the command used for generating the light-emitting control signal according to the feature data. The command includes data representing a correspondence between the feature data and the light-emitting mode of the at least one light element.

In this way, the mounting pad can control the light-emitting mode of the light element according to an external environment.

According to an exemplary embodiment of this application, the mounting area includes metal that can be mated with the magnetic apparatus in a magnetic manner.

In this way, the light element can be easily attached to the mounting pad.

According to an exemplary embodiment of this application, the wireless electric-power transmitting unit of the mounting pad includes at least one wireless electric-power transmitting main coil disposed in the mounting area.

In this way, wireless electric-power transmission of the mounting pad can be achieved.

According to an exemplary embodiment of this application, the mounting pad further includes: an alternating-current receiving unit, configured to receive an alternating current; and an AC-DC conversion unit, configured to convert the alternating current received by the alternating-current receiving unit into a direct current, and transmit the direct current to the wireless electric-power transmitting unit.

In this way, the mounting pad can convert alternating-current input electric power into the electric power used for wireless electric-power transmission.

According to an exemplary embodiment of this application, the light-emitting mode includes at least one of the following: emitting light with a single color; emitting light with a plurality of colors; and emitting light with changeable colors.

In this way, the light element can emit the light with specific patterns and colors.

According to an exemplary embodiment of this application, the wireless communication mode includes any one of WIFI, Bluetooth, 5G, and private wireless communication protocols.

In this way, wireless communication of the mounting pad can be achieved.

Another aspect of an embodiment of this application further provides a light system, including at least one light element and a mounting pad. The light element includes: a light-emitting unit, configured to emit light; an attachment unit, configured to attach the light element to any position on a mounting surface on which the light element is mounted; and a light element information unit, configured to transmit identification information data uniquely identifying the light element and wireless address data of the light element. The mounting pad includes: a mounting area, provided with a mounting surface on which a light element is mounted; and a light element addressing unit, configured to receive the identification information data of the light element and the wireless address data of the light element from the wireless communication unit, so as to perform addressing on the light element.

In this way, each light element can be uniquely identified, and can be accessed during wireless control, so that the independent and specific control of the light element can be achieved.

According to an exemplary embodiment of this application, at least one light element is mounted on the mounting surface so as to form characters or patterns.

In this way, the light can emit light in the form of characters or patterns.

According to an exemplary embodiment of this application, the light element further includes: a wireless communication unit, configured to receive a light-emitting control signal by means of wireless communication. The mounting pad further includes: a wireless control unit, configured to transmit the light-emitting control signal to the wireless communication unit of the light element by means of wireless communication.

In this way, the mounting pad can be configured to control the light-emitting mode of the light element.

According to an exemplary embodiment of this application, that the wireless control unit is configured to transmit the light-emitting control signal to the wireless communication unit of the light element by means of wireless communication includes: according to a result that addressing is performed on the light element, transmitting each of the at least one light-emitting control signal to a wireless communication unit of the corresponding light element in the at least one light element.

In this way, in combination with the addressing result, the corresponding light-emitting control signal is transmitted to the corresponding light element, so as to cause each light element to be correctly controlled to emit light.

According to an exemplary embodiment of this application, the operation of performing addressing on the light element further includes determining position information of each of the at least one light element on the mounting surface of the mounting area of the mounting pad. The operation of transmitting each of the at least one light-emitting control signal to the corresponding light element in the at least one light element further includes determining a correspondence between the light element and the light-emitting control signal according to the characters or patterns of the at least one light element formed on the mounting surface and the position information of each light element.

In this way, which light element should emit what light can be determined according to the characters or patterns of the light element on the mounting surface, so that the at least one light element can achieve a light effect of correctly emitting the characters or patterns.

Another aspect of an embodiment of this application further provides a light element, including: a light-emitting unit, configured to emit light; an attachment unit, configured to attach the light element to any position on a mounting surface on which the light element is mounted; and a light element information unit, configured to transmit identification information data uniquely identifying the light element and wireless address data of the light element.

In this way, each light element can be uniquely identified, and can be accessed during wireless control, so that the independent and specific control of the light element can be achieved.

According to an exemplary embodiment of this application, the light element further includes: a wireless communication unit, configured to receive a light-emitting control signal by means of wireless communication.

In this way, the light element can emit light in a wirelessly controlled manner through the mounting pad.

An exemplary embodiment of this application includes: a mounting area, provided with a mounting surface on which a light element is mounted; and a light element addressing unit, configured to receive identification information data of the light element and wireless address data of the light element from the light element, so as to perform addressing on the light element.

In this way, each light element can be uniquely identified, and can be accessed during wireless control, so that the independent and specific control of the light element can be achieved.

According to an exemplary embodiment of this application, the mounting pad further includes: a wireless control unit, configured to transmit a light-emitting control signal to the light element by means of wireless communication.

In this way, the mounting pad can be configured to control the light-emitting mode of the light element.

According to an exemplary embodiment of this application, that the wireless control unit is configured to transmit the light-emitting control signal to the light element by means of wireless communication includes: according to a result that addressing is performed on the light element, transmitting each of the at least one light-emitting control signal to a wireless communication unit of the corresponding light element in the at least one light element.

In this way, in combination with the addressing result, the corresponding light-emitting control signal is transmitted to the corresponding light element, so as to cause each light element to be correctly controlled to emit light.

According to an exemplary embodiment of this application, the operation of performing addressing on the light element further includes determining position information of each of the at least one light element on the mounting surface of the mounting area of the mounting pad. The operation of transmitting each of the at least one light-emitting control signal to the corresponding light element in the at least one light element further includes determining a correspondence between the light element and the light-emitting control signal according to the characters or patterns of the at least one light element formed on the mounting surface and the position information of each light element.

In this way, which light element should emit what light can be determined according to the characters or patterns of the light element on the mounting surface, so that the at least one light element can achieve a light effect of correctly emitting the characters or patterns.

In the embodiments of this application, the technical solution of freely mounting the light element to the mounting pad and controlling the light element to emit light by means of wireless electric-power transmission and wireless communication is provided, so as to at least resolve the technical problems of low flexibility of mounting the light that emits the light with specific patterns and limited power supply of the light due to a cable. Therefore, the technical effects of improving the flexibility of mounting and controlling the light and freely constructing light-emitting patterns can be achieved.

### BRIEF DESCRIPTION OF THE DRAWINGS

The drawings described herein are used to provide a further understanding of the present application, and constitute a part of the present application. The exemplary embodiments of the present application and the description thereof are used to explain the present application, but do not constitute improper limitations to the present application. In the drawings:

FIG. 1 is a schematic diagram of a light system according to an embodiment of this application.

Figures A, B and C in FIG. 2 respectively are a bottom view, a top view and a schematic diagram of connection between internal units of a light element according to an exemplary embodiment.

FIG. 3 is a schematic diagram of a light element according to an exemplary embodiment of this application.

FIG. 4 is a schematic diagram of a light element according to an exemplary embodiment of this application.

FIG. 5 is a schematic diagram of a mounting pad according to an exemplary embodiment of this application.

FIG. 6 is a schematic diagram of a light system according to an exemplary embodiment of this application.

FIG. 7 is a schematic diagram of a mounting pad according to an exemplary embodiment of this application.

FIG. 8 is a schematic diagram of a mounting pad according to an exemplary embodiment of this application.

FIG. 9 is a schematic diagram of a light element according to an exemplary embodiment of this application.

FIG. 10 is a schematic light-emitting diagram of a light system according to an embodiment of this application.

FIG. 11 is a schematic mounting diagram of a light system according to an embodiment of this application.

In the drawings:
1, Light system;
100, Light element;
101, Light-emitting unit;
103, Attachment unit;
105, Wireless electric-power receiving unit;
1051, Wireless electric-power receiving secondary coil;
107, Light-emitting unit power supply circuit;
109, Light-emitting control unit;
111, Wireless communication unit;
113, Light element information unit;
200, Mounting pad;
203, Mounting area;
205, Wireless electric-power transmitting unit;
2051, Wireless electric-power transmitting main coil;
211, Wireless control unit;
213, Light element addressing unit;
221, Light-emitting control signal generation unit;
223, Command acquisition unit;
2231, Intelligent device communication unit;
2233, Sensor;
2235, Feature extraction unit;
2237, Command generation unit;
225, Alternating-current receiving unit;
227, AC-DC conversion unit;
30, Intelligent device;
401, Plug;
403, Socket.

### DETAILED DESCRIPTION

In order to enable those skilled in the art to better understand the solutions of this application, the technical solutions in the embodiments of this application will be clearly and completely described below in combination with the drawings in the embodiments of this application. It is apparent that the described embodiments are only part of the embodiments of this application, not all the embodiments. All other embodiments obtained by those of ordinary skill in the art on the basis of the embodiments in this application without creative work shall fall within the scope of protection of this application.

It is to be noted that terms “first”, “second” and the like in the description, claims and the above-mentioned drawings of this application are used for distinguishing similar objects rather than describing a specific sequence or a precedence order. It should be understood that the data used in such a way may be exchanged where appropriate, in order that the embodiments of this application described here can be implemented in an order other than those illustrated or described herein. In addition, terms “include” and “have” and any variations thereof are intended to cover non-exclusive inclusions. For example, it is not limited for processes, methods, systems, products or devices containing a series of steps or modules or units to clearly list those steps or modules or units, and other steps or modules or units which are not clearly listed or are inherent to these processes, methods, products or devices may be included instead.

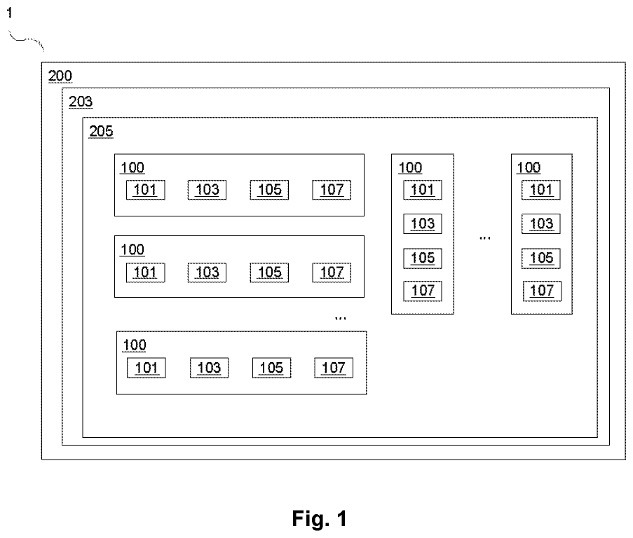

An embodiment of this application provides a light system. FIG. 1 is a schematic diagram of a light system according to an embodiment of this application. As shown in FIG. 1, the light system 1 according to this embodiment of this application includes at least one light element 100 and a mounting pad 200. The number of the light elements 100 may be 1, or may be any number, for example, 2, 3, 4, 5, N, where N is an integer.

The light element 100 includes a light-emitting unit 101, an attachment unit 103, a wireless electric-power receiving unit 105 and a light-emitting unit power supply circuit 107.

The light-emitting unit 101 is configured to emit light. The attachment unit 103 is configured to attach the light element 100 to any position on a mounting surface on which the light element 100 is mounted. The wireless electric-power receiving unit 105 is configured to receive electric power for driving the light element 100 on the mounting surface by means of wireless electric-power transmission. The light-emitting unit power supply circuit 107 is connected to the wireless electric-power receiving unit 105 and the light-emitting unit 101 and configured to transmit the electric power received by the wireless electric-power receiving unit 105 to the light-emitting unit 101.

The mounting pad 200 includes a mounting area 203 and a wireless electric-power transmitting unit 205.

The mounting area 203 is provided with a mounting surface on which a light element 100 is mounted. The wireless electric-power transmitting unit 205 is configured to transmit the electric power to the wireless electric-power receiving unit 105 of the light element 100 on the mounting surface by means of wireless electric-power transmission.

The light-emitting unit 101 is, for example, provided with an LED, or other forms of light-emitting elements, so as to emit light. A shape of the light element 100 is not limited, which may use a circle, an ellipse, a polygon (including but not limited to a triangle, a quadrilateral, and a pentagon) or a customized shape. FIG. 1 shows a quadrilateral light element 100. A plurality of quadrilateral light elements 100 are attached to the mounting area 203 of the mounting pad 200. The arrangement of the light elements 100 in FIG. 1 is exemplary. Actually, at least one light element 100 may be disposed horizontally and vertically as shown in FIG. 1, or may be obliquely disposed at any angle. In addition, it is not necessary to align the light elements 100. Each light element 100 may be attached to any position of the mounting area 203 by means of the attachment unit 103. The plurality of light elements 100 may have different shapes, so that, based on the arbitrary placement and respective shapes of the light elements 100, any pattern can be formed according to actual requirements, and then the light elements are disposed in the mounting area 203.

When the light element 100 is located in the mounting area 203, wireless electric-power transmission between the wireless electric-power receiving unit 105 of the light element 100 and the wireless electric-power transmitting unit 205 of the mounting pad 200 is achieved. According to an exemplary embodiment, the wireless electric-power transmitting unit 205 is disposed in the mounting area 203 and surrounds a predetermined area in the mounting area 203. Then, the wireless electric-power transmitting unit 205 supplies wireless electric power to an electronic device in the area. When being located in the mounting area 203, the light element 100 is also located in the area surrounded by the wireless electric-power transmitting unit 205. The wireless electric-power transmitting unit 205 then supplies the wireless electric power to the wireless electric-power receiving unit 105 of the light element 100. After the wireless electric-power receiving unit 105 of the light element 100 receives the electric power, the electric power used for emitting light is supplied to the light element 100 via the light-emitting unit power supply circuit 107.

Figures A, B and C in FIG. 2 respectively are a bottom view, a top view and a schematic diagram of connection between internal units of a light element according to an exemplary embodiment.

As shown in FIG. 2, the light element 100 according to this exemplary embodiment is quadrilateral. A bottom surface of the light element 100 is a surface that is attached to the mounting area 203. Figure A in FIG. 2 is a schematic diagram of the light element 100 viewed from this bottom surface. As shown in Figure A in FIG. 2, the attachment unit 103 is located on the bottom surface of the light element 100. Therefore, when the bottom surface of the light element 100 is attached to the mounting area 203, an effect of fixing the bottom surface of the light element 100 to the mounting surface of the mounting area 203 can be achieved. A position of the attachment unit 103 shown in Figure A in FIG. 2 is exemplary. The attachment unit 103 may be disposed in any position of the bottom surface of the light element 100, preferably, may be disposed in a predetermined area in the center of the bottom surface of the light element 100, or cover the bottom surface of the light element 100. The number of the attachment units 103 shown in Figure A in FIG. 2 is exemplary. The number of the attachment units 103 may be any number, for example, may be an integer greater than 1. Preferably, there may be 2 attachment units 103, which are respectively located on two sides of the bottom surface of the light element 100. There may be 3 attachment units 103, which are located on the bottom surface of the light element 100 side by side. There may be 4 attachment units 103, each of which is located at each of four corners of the light element 100. Any number of the attachment units 103 (including more) can be located on the bottom surface of the light element 100 in an appropriate manner.

A top surface of the light element 100 is a surface that is opposite to the bottom surface attached to the mounting area 203. Figure B in FIG. 2 is a schematic diagram of the light element 100 viewed from this top surface. As shown in Figure B in FIG. 2, the light-emitting unit 101 is disposed on the top surface of the light element 100, so that light can be emitted outwards from the top surface of the light element 100. A position of the light-emitting unit 101 shown in Figure B in FIG. 2 is exemplary. The light-emitting unit 101 may be disposed in any position of the top surface of the light element 100, preferably, may be disposed in a predetermined area in the center of the top surface of the light element 100, or cover the top surface of the light element 100. The number of the light-emitting units 101 shown in Figure B in FIG. 2 is exemplary. The number of the light-emitting units 101 may be any number, for example, may be an integer greater than 1. Preferably, there may be a plurality of light-emitting units 101, which are located on the top surface of the light element 100 side by side. The plurality of light-emitting units 101 may be located on the top surface of the light element 100 in a predetermined pattern. Any number of the light-emitting units 101 (including more) can be located on the top surface of the light element 100 in an appropriate manner.

In addition, in another implementation, the light-emitting units 101 are disposed in any one or more surfaces of the light element 100 in any number.

Figure C in FIG. 2 is a schematic diagram of connection between internal units of a light element according to an exemplary embodiment. A position of a unit or a module shown in Figure C in FIG. 2 is merely exemplary, and should not be construed as limitations to the position of the unit or the module. As shown in Figure C in FIG. 2, the wireless electric-power receiving unit 105 is connected to the light-emitting unit power supply circuit 107, and the light-emitting unit power supply circuit 107 is connected to the light-emitting unit 101. The electric power is transmitted from the wireless electric-power receiving unit 105 to the light-emitting unit power supply circuit 107, and transmitted to the light-emitting unit 101 by means of the light-emitting unit power supply circuit 107, so as to drive the light-emitting unit 101 to emit light.

In this way, a mounting method of the light element is flexible, and a power supply method is not affected by a cable.

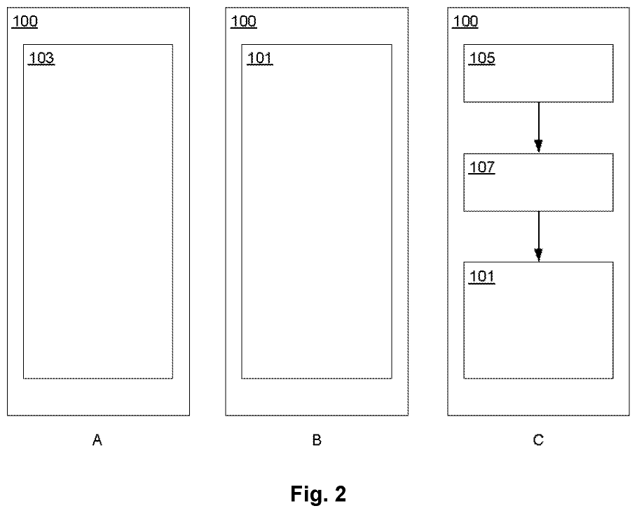

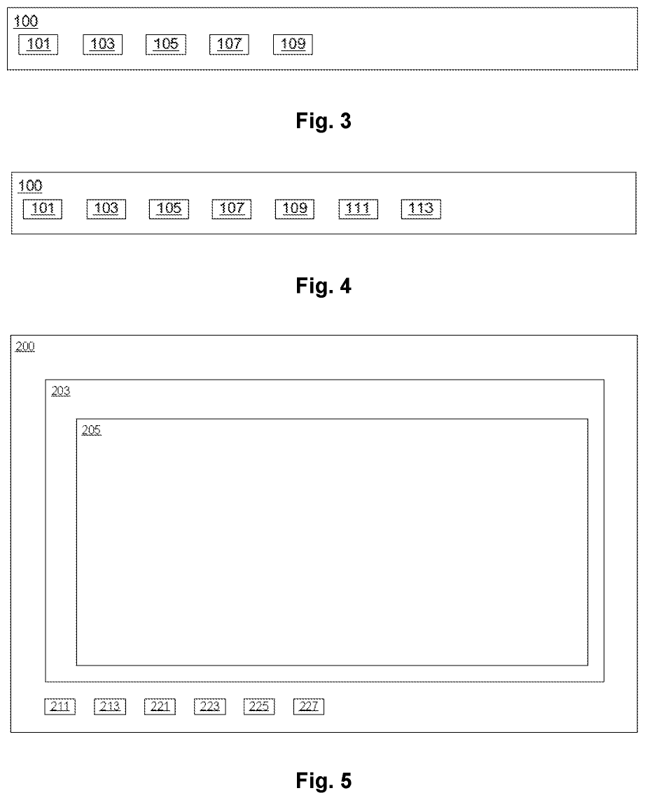

FIG. 3 is a schematic diagram of a light element 100 according to an exemplary embodiment of this application.

As shown in FIG. 3, according to an exemplary embodiment of this application, the light element 100 further includes a light-emitting control unit 109. The light-emitting control unit 109 is configured to control the light-emitting unit 101 to emit light according to a light-emitting control signal for controlling a light-emitting mode of the light-emitting unit 101. The light-emitting control signal may be acquired externally, or may be internally stored or generated by the light-emitting control unit 109. When the light-emitting unit 101 is controlled to emit light according to the light-emitting control signal, the light-emitting unit 101 emits light in the corresponding light-emitting mode.

The light-emitting control unit 109 is, for example, provided with a switch. When the switch is in different states, the light-emitting unit 101 emits light in different light-emitting modes. For example, when the switch is in a first state in a plurality of states, and when the light element 100 is mounted in the mounting area 203 and emits light by receiving wireless electric power, the light element 100 emits the light in a first light-emitting mode.

In this way, the light element can be controlled to emit the light required.

According to an exemplary embodiment of this application, the light-emitting control unit 109 is configured to generate the light-emitting control signal for controlling the light-emitting mode of the light-emitting unit 101. The light-emitting control unit 109 may acquire condition data, and emit the light-emitting control signal corresponding to the light-emitting mode based on the condition data. For example, a certain condition corresponds to a specific light-emitting mode. The light element 100 may optionally include a memory, and the condition data may be stored in the memory. The light-emitting control unit 109 may randomly generate the light-emitting control signal. The light-emitting control unit 109 may also generate the light-emitting control signal corresponding to a predetermined light-emitting mode at predetermined time. In such an implementation, the light element 100 can achieve self-adjustment of the light-emitting modes by only externally receiving the electric power, without receiving external control.

In this way, the light element can automatically control its own light-emitting mode.

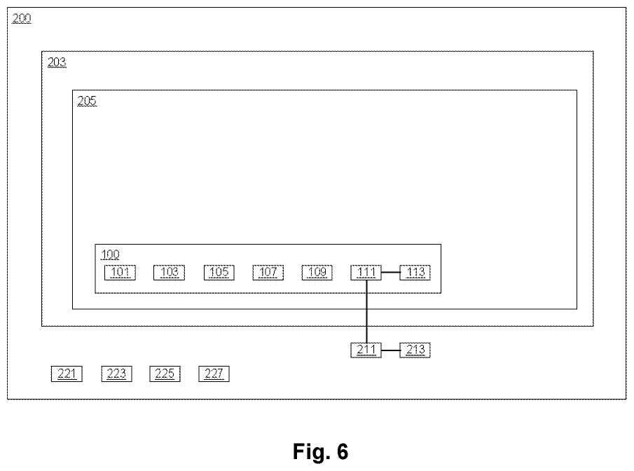

FIG. 4 is a schematic diagram of a light element according to an exemplary embodiment of this application. FIG. 5 is a schematic diagram of a mounting pad according to an exemplary embodiment of this application. FIG. 6 is a schematic diagram of a light system according to an exemplary embodiment of this application.

According to an exemplary embodiment of this application, the light element 100 shown in FIG. 4 further includes a wireless communication unit 111. The wireless communication unit 111 is configured to receive the light-emitting control signal by means of wireless communication, and transmit the light-emitting control signal to the light-emitting control unit 101. The mounting pad 200 shown in FIG. 5 further includes a wireless control unit 211. The wireless control unit 211 is configured to transmit the light-emitting control signal to the wireless communication unit 111 of the light element 100 by means of wireless communication. In such an implementation, a wireless communication is achieved between the wireless communication unit 111 and the wireless control unit 211. The mounting pad 200 wirelessly controls the light-emitting mode of the light element 100 by means the wireless control unit 211. As shown in FIG. 6, in such an implementation, the light-emitting control signal is not generated by the light element 100 itself, but transmitted to the light element 100 by the mounting pad 200. That is to say, in addition to serving as a component for mounting the light element 100 and supplying power to the light element 100, the mounting pad 200 also serves as a control pad of the light element 100. In an implementation, the mounting pad 200 is provided with a switch. When the switch is in different states, different light-emitting control signals are transmitted to the light element 100, so that the light-emitting unit 101 is controlled to emit light in different light-emitting modes. For example, when the switch is in a first state in a plurality of states, and when the light element 100 is mounted in the mounting area 203 and emits light by receiving wireless electric power, the light element 100 emits the light in a first light-emitting mode. In an implementation, an input apparatus is disposed on the mounting pad 200 and configured to receive the light-emitting control signal. The mounting pad 200 transmits the received light-emitting control signal to the light element 100. The input apparatus is not limited to a mouse, a keyboard, a man-machine graphical interface, and the like.

In this way, the light element can emit light in a wirelessly controlled manner through the mounting pad.

According to an exemplary embodiment of this application, the light element 100 shown in FIG. 4 further includes: a light element information unit 113, configured to transmit identification information data uniquely identifying the light element 100 and wireless address data of the light element 100 by means of the wireless communication unit 111. As shown in FIG. 5, the mounting pad 200 further includes a light element addressing unit 213. The light element addressing unit 213 is configured to receive the identification information data of the light element 100 and the wireless address data of the light element 100 from the light element information unit 113, so as to perform addressing on the light element 100. As shown in FIG. 6, the identification information data of the light element 100 and the wireless address data of the light element 100 are transmitted to the wireless communication unit 111 from the light element information unit 113, then transmitted to the wireless control unit 211 of the mounting pad 200 by means of the wireless communication unit 111, and finally transmitted to the light element addressing unit 213 by the wireless control unit 211. When any one or more of the plurality of light elements 100 is required to be controlled in a targeted manner, the light element addressing unit 213 can identify the corresponding light elements 100, and provides control of the corresponding light elements 100 based on an addressing result.

In this way, each light element can be uniquely identified, and can be accessed during wireless control, so that the independent and specific control of the light element can be achieved.

As shown in FIG. 6, according to an exemplary embodiment of this application, the mounting pad 200 further includes: a light-emitting control signal generation unit 221, configured to generate the light-emitting control signal for controlling the light-emitting mode of the light-emitting unit 101, and transmit the light-emitting control signal to the wireless control unit 211.

In this way, the mounting pad can be configured to control the light-emitting mode of the light element.

As shown in FIG. 6, according to an exemplary embodiment of this application, the mounting pad 200 further includes: a command acquisition unit 223, configured to acquire a command used for generating the light-emitting control signal, and transmit the command to the light-emitting control signal generation unit 221. The light-emitting control signal generation unit 221 generates the light-emitting control signal according to the command.

In this way, the mounting pad can control the light-emitting mode of the light element according to the specific command.

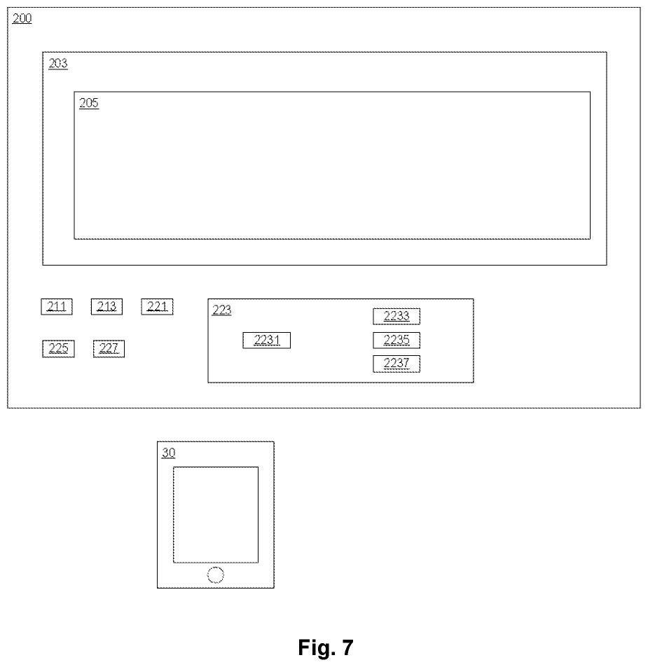

FIG. 7 is a schematic diagram of a mounting pad according to an exemplary embodiment of this application. As shown in FIG. 7, according to an exemplary embodiment of this application, the command acquisition unit 223 includes: an intelligent device communication unit 2231, configured to acquire the command used for generating the light-emitting control signal from an intelligent device 30. The command includes data representing selection of the light-emitting mode for the at least one light element 100. The intelligent device 30 is, for example, a smart phone, a tablet computer, a PC, a remote control, or the like. By means of the intelligent device, a user can input a specific command to select a desired light-emitting mode. The intelligent device transmits the command to the intelligent device communication unit 2231. Then, the command acquisition unit 223 may generate the light-emitting control signal corresponding to the light-emitting mode so as to control the light element 100.

In this way, the intelligent device can be used to control the light-emitting mode of the light element.

FIG. 7 is a schematic diagram of a mounting pad according to an exemplary embodiment of this application. As shown in FIG. 7, according to an exemplary embodiment of this application, the command acquisition unit 223 includes a sensor 2233, a feature extraction unit 2235 and a command generation unit 2237.

The sensor 2233 is configured to acquire sensing data obtained by sensing environment information. The environment information includes at least one of light, temperature, or sound. The feature extraction unit 2235 is configured to acquire the sensing data and extract feature data of the environment information. The command generation unit 2237 is configured to acquire the command used for generating the light-emitting control signal according to the feature data. The command includes data representing a correspondence between the feature data and the light-emitting mode of the at least one light element 100.

For example, the sensor 2233 may include a light sensor, which can sense ambient light. When the intensity and color temperature of the ambient light are within a predetermined numerical range, the light-emitting mode of the light-emitting unit 101 corresponds to the predetermined light-emitting mode. The sensor 2233 may include a thermometer, which can sense the ambient light. When the ambient light is within a predetermined numerical range, the light-emitting mode of the light-emitting unit 101 corresponds to the predetermined light-emitting mode. The sensor 2233 may include a microphone, which can collect ambient sound. When the intensity, timbre and melody of the ambient sound are within a predetermined condition, the light-emitting mode of the light-emitting unit 101 corresponds to the predetermined light-emitting mode. For example, if the microphone collects specific sentence voice or music, the light-emitting unit 101 is controlled to emit light in the predetermined light-emitting mode or is switched among different light-emitting modes.

In this way, the mounting pad can control the light-emitting mode of the light element according to an external environment.

According to an exemplary embodiment of this application, the attachment unit 103 includes at least one of a magnetic apparatus or a double-sided tape.

In this way, the mounting of the light element is not limited to a slot, a cable and the like; and the light element may be mounted at any angle and position, can be easily attached to the mounting pad, and form a required pattern.

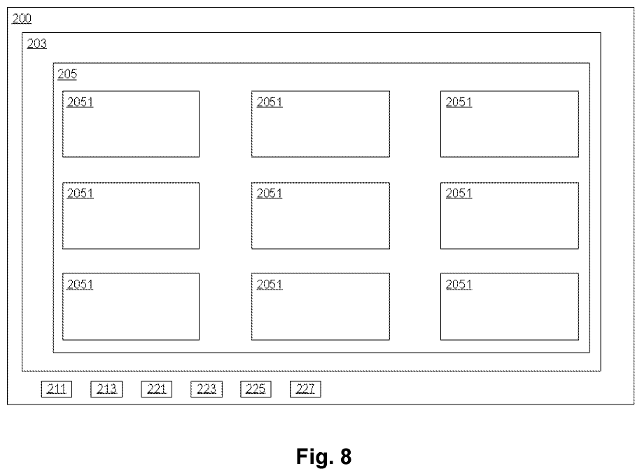

FIG. 8 is a schematic diagram of a mounting pad according to an exemplary embodiment of this application. As shown in FIG. 8, according to an exemplary embodiment of this application, the wireless electric-power transmitting unit 205 of the mounting pad 200 includes at least one wireless electric-power transmitting main coil 2051 disposed in the mounting area 203. The number of the wireless electric-power transmitting main coils 2051 may be an integer greater than 1. Although 9 wireless electric-power transmitting main coils 2051 are shown in FIG. 8, it is to be understood that, at least one wireless electric-power transmitting main coil 2051 may be disposed in any position in the mounting area 203, as long as the number and position of the wireless electric-power transmitting main coil can stably transmit the wireless electric power to the light element 100 in the mounting area 203. Preferably, the plurality of wireless electric-power transmitting main coils 2051 may be uniformly disposed in the mounting area 203, so that, regardless of how at least one light element 100 is placed in the mounting area 203, the wireless electric power can be supplied to each light element 100. Preferably, one wireless electric-power transmitting main coil 2051 may be used, and an area surrounded by the wireless electric-power transmitting main coil 2051 covers the entire mounting area 203.

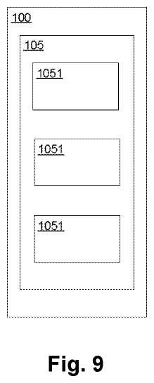

FIG. 9 is a schematic diagram of a light element according to an exemplary embodiment of this application. As shown in FIG. 9, the wireless electric-power receiving unit 105 of the light element 100 comprises at least one wireless electric-power receiving secondary coil 1051. The number of the wireless electric-power receiving secondary coil 1051 may be an integer greater than 1. Although 3 wireless electric-power receiving secondary coil 1051 are shown in FIG. 9, it is to be understood that, at least one wireless electric-power receiving secondary coil 1051 may be disposed in any position in the light element 100, as long as the number and position of the wireless electric-power receiving secondary coil can stably receive the wireless electric power from the at least one wireless electric-power transmitting main coil 2051 of the mounting area 203. Preferably, the plurality of wireless electric-power receiving secondary coils 1051 may be uniformly disposed in the light element 100, so that, regardless of how the light element 100 is placed in the mounting area 203, the wireless electric power can be received from the at least one wireless electric-power transmitting main coil 2051. Preferably, one wireless electric-power receiving secondary coil 1051 may be used.

In this way, wireless electric-power transmission between the light element and the mounting pad can be achieved.

As shown in FIG. 8, according to an exemplary embodiment of this application, the mounting pad 200 further includes an alternating-current receiving unit 225 and an AC-DC conversion unit 227.

The alternating-current receiving unit 225 is configured to receive an alternating current. The AC-DC conversion unit 227 is configured to convert the alternating current received by the alternating-current receiving unit 225 into a direct current, and transmit the direct current to the wireless electric-power transmitting unit 205. Specifically, the alternating-current receiving unit 225 may be connected to an alternating current power supply, such as a power supply of 110V, 120V, and 220V, by using a plug and a cable.

In this way, the mounting pad can convert alternating-current input electric power into the electric power required for driving the light element.

According to an exemplary embodiment of this application, the light-emitting unit 101 has at least one of the following a plurality of light-emitting modes: emitting light with a single color; emitting light with a plurality of colors; and emitting light with changeable colors. Specifically, the light-emitting unit 101 may emit an RGB light, which may be switched among a plurality of colors with a predetermined rule. In an exemplary implementation, when the microphone of the mounting pad 200 collects music, the light-emitting unit 101 can be controlled to generate rhythmic light with music. At the first time, one or more of the plurality of light-emitting units 101 may not emit light, and other light-emitting units 101 emit the light with predetermined colors. At the second time, the other one or more of the plurality of light-emitting units 101 may not emit light, and other light-emitting units 101 emit the light with predetermined colors.

In this way, the light element can emit the light with specific patterns and colors.

According to an exemplary embodiment of this application, the wireless communication mode includes any one of WIFI, Bluetooth, 5G, and private wireless communication protocols.

In this way, wireless communication between the light element and the mounting pad can be achieved.

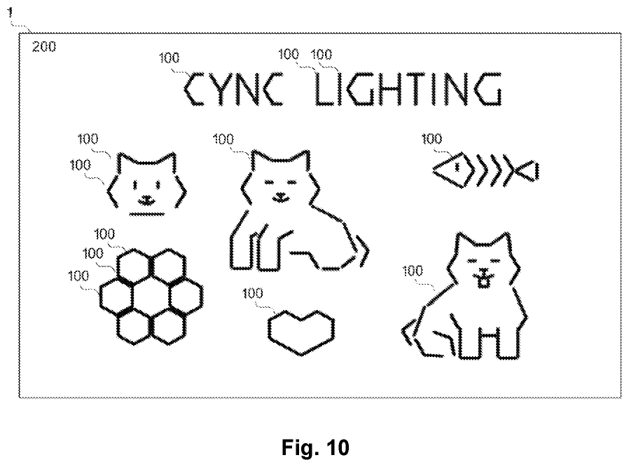

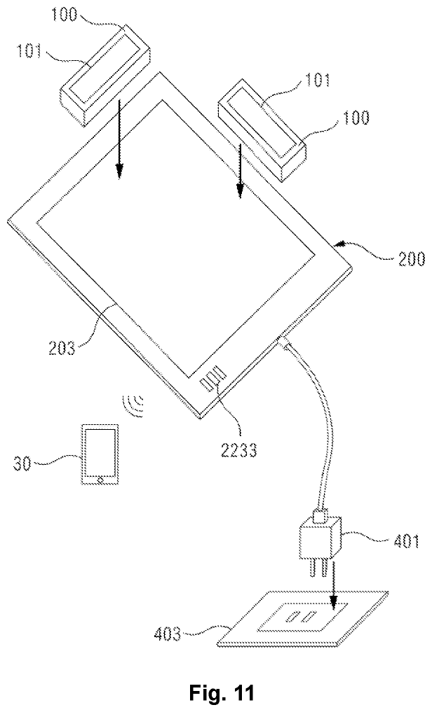

FIG. 10 is a schematic light-emitting diagram of a light system according to an embodiment of this application. FIG. 10 shows the light system 1. The plurality of light elements 100 are mounted on the mounting pad 200 in a manner of letters, characters or patterns. According to the technical solution of this application, the plurality of light elements 100 can be freely disposed and emit light. The mounting pad 200, for example, further includes a housing, so as to be mounted on, for example, a wall or a ceiling by means of a hanging structure disposed on the housing or other fixation structures.

FIG. 11 is a schematic mounting diagram of a light system according to an embodiment of this application. As shown in FIG. 11, the mounting pad 200 is plugged in the socket 403 by means of the plug 401, so as to acquire the electric power. The light element 100 includes a light-emitting unit 101. At least one light element 100 (there are two light elements merely exemplarily shown in FIG. 11) is mounted in the mounting area 203 of the mounting pad 200 by means of magnetic attraction or adhesion. More specifically, since the light element 100 can be mounted in any position on the mounting surface of the mounting area 203, at least one light element 100 may be placed to form any characters and/or patterns (referring to FIG. 10) according to actual requirements.

At least one light element 100 can be addressed according to this embodiment of this application. The light-emitting control signal transmitted corresponding to the identification information data and the wireless address data according to the identification information data and wireless address data of each light element 100. In this way, each light element 100 may be separately controlled to emit different light effects.

In an exemplary implementation, at least one light element 100 forms characters and/or patterns. In addition, the position information of each light element 100 on the mounting surface of the mounting area 203 of the mounting pad 200 can also be determined. Therefore, which light element 100 emits what light effect can be determined according to the light effect of a corresponding portion of the characters and/or patterns.

For example, in combination with FIG. 10, a letter “C” is expected to emit a rhythmic light effect. Correspondingly, at least one light element 100 corresponding to the position of the letter “C” on the mounting area 203 is determined as the light element that receives the light-emitting control signal controlling the rhythmic light effect. Next, according to the identification information data and wireless address data of each light element 100, the light-emitting control signal is transmitted to each light element 100, so that the rhythmic light effect of the light element 100 forming the letter “C” can be achieved.

In a further exemplary implementation, the mounting pad 200 communicates with the intelligent device 30. An application used for controlling the light emitting of the light element 100 is installed on the intelligent device 30. The user can acquire, from the application and in combination with an addressing result, the characters and/or patterns formed by the at least one light element 100 on the mounting pad 200 and a basic state of each light element 100. By controlling the light effect that is expected to be emitted by the characters and/or patterns formed by the light element 100 on the intelligent device 30, the mounting pad 200 is controlled to transmit the light-emitting control signal controlling each light element 100 to the corresponding light element 100, so that the light element 100 on the mounting pad 200 can emit the light effect of the characters and/or patterns. Alternatively, the intelligent device 30 may directly transmit the light-emitting control signal to the corresponding light element 100, so that the light element 100 on the mounting pad 200 can emit the light effect of the characters and/or patterns.

In addition, the sensor 2233 is disposed on the mounting pad 200, for example, a microphone. The microphone acquires sound in an environment. According to different sounds, the mounting pad 200 can control the light effect of the light element 100. According to the sensor 2233, which light effect solution may be stored in the mounting pad 200 is determined, or may be designed by means of the intelligent device 30. For example, when the microphone acquires a piece of music, the feature extraction unit of the mounting pad 200 extracts the feature data of a sound feature. The command generation unit is configured to acquire a command used for generating the light-emitting control signal according to the feature data. The command includes data representing a correspondence between the feature data and the light-emitting mode (light effect) of the at least one light element 100. Alternatively, the feature data is transmitted to the intelligent device 30, and the intelligent device 30 determines the light-emitting mode (light effect) of the at least one light element 100 corresponding to the feature data according to a preset condition or the input of the user, so that the mounting pad 200 is controlled to transmit the light-emitting control signal or directly transmit the light-emitting control signal, so as to control the light effect of the light element 100.

The light system according to the embodiment of this application is as described above. The light element and mounting pad in the light system may also be separately implemented.

An embodiment of this application further provides a light element 100, including a light-emitting unit 101, an attachment unit 103, a wireless electric-power receiving unit 105 and a light-emitting unit power supply circuit 107.

The light-emitting unit 101 is configured to emit light. The attachment unit 103 is configured to attach the light element 100 to any position on a mounting surface on which the light element 100 is mounted. The wireless electric-power receiving unit 105 is configured to receive electric power for driving the light element 100 by means of wireless electric-power transmission. The light-emitting unit power supply circuit 107 is connected to the wireless electric-power receiving unit 105 and the light-emitting unit 101 and configured to transmit the electric power received by the wireless electric-power receiving unit 105 to the light-emitting unit 101.

In this way, a mounting method of the light element is flexible, and a power supply method is not affected by a cable.

According to an exemplary embodiment of this application, the light element 100 further includes a light-emitting control unit 109. The light-emitting control unit 109 is configured to control the light-emitting unit 101 to emit light according to a light-emitting control signal for controlling a light-emitting mode of the light-emitting unit 101.

In this way, the light element can be controlled to emit the light required.

According to an exemplary embodiment of this application, the light-emitting control unit 109 is configured to generate the light-emitting control signal for controlling the light-emitting mode of the light-emitting unit 101.

In this way, the light element can automatically control its own light-emitting mode.

According to an exemplary embodiment of this application, the light element 100 further includes: a wireless communication unit 111, configured to receive the light-emitting control signal by means of wireless communication, and transmit the light-emitting control signal to the light-emitting control unit 101.

In this way, the light element can emit light in a wirelessly controlled manner.

According to an exemplary embodiment of this application, each light element 100 further includes: a light element information unit 113, configured to transmit identification information data uniquely identifying the light element 100 and wireless address data of the light element 100 by means of the wireless communication unit 111.

In this way, each light element can be uniquely identified, and can be accessed during wireless control, so that the independent and specific control of the light element can be achieved.

According to an exemplary embodiment of this application, the attachment unit 103 includes at least one of a magnetic apparatus or a double-sided tape.

In this way, the light element can be easily attached to a mounting position.

According to an exemplary embodiment of this application, the wireless electric-power receiving unit 105 of the light element 100 includes at least one wireless electric-power receiving secondary coil.

In this way, wireless electric-power receiving of the light element can be achieved.

According to an exemplary embodiment of this application, the light element 100 further includes an electric-power storage unit, disposed between the wireless electric-power receiving unit 105 and the light-emitting unit power supply circuit 107, and configured to store the electric power received by the wireless electric-power receiving unit 105 and transmit the electric power to the light-emitting unit power supply circuit 107.

In this way, the light element can store the electric power, so as to emit light when not being powered externally.

According to an exemplary embodiment of this application, the light-emitting unit 101 has at least one of the following a plurality of light-emitting modes: emitting light with a single color; emitting light with a plurality of colors; and emitting light with changeable colors.

In this way, the light element can emit the light with specific patterns and colors.

According to an exemplary embodiment of this application, the wireless communication mode includes any one of WIFI, Bluetooth, 5G, and private wireless communication protocols.

In this way, wireless communication of the light element can be achieved.

Another aspect of an embodiment of this application further provides a mounting pad 200 of a light, including a mounting area 203 and a wireless electric-power transmitting unit 205.

The mounting area 203 is provided with a mounting surface on which a light element is mounted. The wireless electric-power transmitting unit 205 is configured to transmit electric power to the light element on the mounting surface by means of wireless electric-power transmission.

In this way, a mounting method of the light element is flexible, and a power supply method is not affected by a cable.

According to an exemplary embodiment of this application, the mounting pad 200 further includes: a wireless control unit 211, configured to transmit a light-emitting control signal for controlling a light-emitting mode to the light element by means of wireless communication.

In this way, the light element can emit light in a wirelessly controlled manner through the mounting pad.

According to an exemplary embodiment of this application, the mounting pad 200 further includes: a light element addressing unit 213, configured to receive identification information data of the light element and wireless address data of the light element from the light element, so as to perform addressing on the light element.

In this way, each light element can be uniquely identified, and can be accessed during wireless control, so that the independent and specific control of the light element can be achieved.

According to an exemplary embodiment of this application, the mounting pad 200 further includes: a light-emitting control signal generation unit 221, configured to generate the light-emitting control signal for controlling the light-emitting mode of the light element, and transmit the light-emitting control signal to the wireless control unit 211.

In this way, the mounting pad can be configured to control the light-emitting mode of the light element.

According to an exemplary embodiment of this application, the mounting pad 200 further includes: a command acquisition unit 223, configured to acquire a command used for generating the light-emitting control signal, and transmit the command to the light-emitting control signal generation unit 221. The light-emitting control signal generation unit 221 generates the light-emitting control signal according to the command.

In this way, the mounting pad can control the light-emitting mode of the light element according to the specific command.

According to an exemplary embodiment of this application, the command acquisition unit 223 includes: an intelligent device communication unit 2231, configured to acquire the command used for generating the light-emitting control signal from an intelligent device. The command comprises data representing selection of the light-emitting mode for the at least one light element.

In this way, the intelligent device can be used to control the light-emitting mode of the light element.

According to an exemplary embodiment of this application, the command acquisition unit 223 includes a sensor 2233, a feature extraction unit 2235 and a command generation unit 2237.

The sensor 2233 is configured to acquire sensing data obtained by sensing environment information. The environment information includes at least one of light, temperature, or sound. The feature extraction unit 2235 is configured to acquire the sensing data and extract feature data of the environment information. The command generation unit 2237 is configured to acquire the command used for generating the light-emitting control signal according to the feature data. The command includes data representing a correspondence between the feature data and the light-emitting mode of the at least one light element.

In this way, the mounting pad can control the light-emitting mode of the light element according to an external environment.

According to an exemplary embodiment of this application, the mounting area 203 includes metal that can be mated with the magnetic apparatus in a magnetic manner.

In this way, the light element can be easily attached to the mounting pad.

According to an exemplary embodiment of this application, the wireless electric-power transmitting unit 205 of the mounting pad 200 includes at least one wireless electric-power transmitting main coil disposed in the mounting area 203.

In this way, wireless electric-power transmission of the mounting pad can be achieved.

According to an exemplary embodiment of this application, the mounting pad 200 further includes an alternating-current receiving unit 225 and an AC-DC conversion unit 227.

The alternating-current receiving unit 225 is configured to receive an alternating current. The AC-DC conversion unit 227 is configured to convert the alternating current received by the alternating-current receiving unit 225 into a direct current, and transmit the direct current to the wireless electric-power transmitting unit 205.

In this way, the mounting pad can convert alternating-current input electric power into the electric power used for wireless electric-power transmission.

According to an exemplary embodiment of this application, the light-emitting mode includes at least one of the following: emitting light with a single color; emitting light with a plurality of colors; and emitting light with changeable colors.

In this way, the light element can emit the light with specific patterns and colors.

According to an exemplary embodiment of this application, the wireless communication mode includes any one of WIFI, Bluetooth, 5G, and private wireless communication protocols.

In this way, wireless communication of the mounting pad can be achieved.

For the implementation of the light element and the mounting pad according to the above implementation, please refer to the light system according to the embodiment of this application, and details are not described herein again.

In the embodiments of this application, the technical solution of freely mounting the light element to the mounting pad and controlling the light element to emit light by means of wireless electric-power transmission and wireless communication is provided, so as to at least resolve the technical problems of low flexibility of mounting the light that emits specific patterns and limited power supply of the light due to a cable. Therefore, the technical effects of improving the flexibility of mounting and controlling the light and freely constructing light-emitting patterns can be achieved.

In the above embodiments of this application, the description of the embodiments has its own focus. For parts that are not described in detail in a certain embodiment, reference may be made to related descriptions of other embodiments.

In the several embodiments provided in this application, it should be understood that, the disclosed technical content can be implemented in other ways. The apparatus embodiments described above are merely illustrative. For example, the division of the units or modules is merely a logical function division, and there may be other divisions in actual implementation. For example, a plurality of units or modules or components may be combined or integrated into another system, or some features can be ignored, or not implemented. In addition, the displayed or discussed mutual coupling or direct coupling or communication connection may be indirect coupling or communication connection through some interfaces, modules or units, and may be in electrical or other forms.

The units described as separate components may or may not be physically separated. The components displayed as units or modules may or may not be physical units or modules, that is, the components may be located in one place, or may be distributed on the plurality of network units or modules. Part or all of the units or modules may be selected according to actual requirements to achieve the purposes of the solutions of this embodiment.

In addition, the functional units or modules in the various embodiments of this application may be integrated into one processing unit or module, or each unit or module may exist alone physically, or two or more than two units or modules may be integrated into one unit or module. The above integrated unit or module can be implemented in the form of hardware, or can be implemented in the form of a software functional unit or module.

If the integrated unit is implemented in the form of the software functional unit and sold or used as an independent product, it can be stored in the computer readable storage medium. Based on this understanding, the technical solutions of the present application essentially or the parts that contribute to the prior art, all or part of the technical solutions can be embodied in the form of a software product. The computer software product is stored in a storage medium, including a plurality of instructions for causing a computer device (which may be a personal computer, a server, or a network device, and the like) to execute all or part of the steps of the method described in the various embodiments of the present application. The foregoing storage medium includes a USB flash disk, a Read-Only Memory (ROM), a Random Access Memory (RAM), and various media that can store program codes, such as a mobile hard disk, a magnetic disk, or an optical disk.

The above description is merely preferred implementations of this application, and it should be noted that persons of ordinary skill in the art may also make several improvements and refinements without departing from the principle of this application, and it should not be considered that these improvements and refinements shall fall within the protection scope of this application.

1. A light system, comprising at least one light element and a mounting pad, wherein the light element comprises:
a light-emitting unit, configured to emit light;
an attachment unit, configured to attach the light element to any position on a mounting surface on which the light element is mounted;
a wireless electric-power receiving unit, configured to receive electric power for driving the light element on the mounting surface by means of wireless electric-power transmission; and
a light-emitting unit power supply circuit, connected to the wireless electric-power receiving unit and the light-emitting unit and configured to transmit the electric power received by the wireless electric-power receiving unit to the light-emitting unit; and
the mounting pad comprises:
a mounting area, provided with the mounting surface on which the light element is mounted; and
a wireless electric-power transmitting unit, configured to transmit the electric power to the wireless electric-power receiving unit of the light element (100) on the mounting surface by means of wireless electric-power transmission.

2. The light system according to claim 1, wherein
the at least one light element is mounted on the mounting surface so as to form characters or patterns.

3. The light system according to claim 2, wherein
the light element further comprises a light-emitting control unit, and the light-emitting control unit is configured to control the light-emitting unit to emit light according to a light-emitting control signal for controlling a light-emitting mode of the light-emitting unit.

4. The light system according to claim 3, wherein
the light-emitting control unit is configured to generate the light-emitting control signal for controlling the light-emitting mode of the light-emitting unit.

5. The light system according to claim 3, wherein
the light element further comprises:
a wireless communication unit, configured to receive the light-emitting control signal by means of wireless communication, and transmit the light-emitting control signal to the light-emitting control unit; and
the mounting pad further comprises:
a wireless control unit, configured to transmit the light-emitting control signal to the wireless communication unit of the light element by means of wireless communication.

6. The light system according to claim 5, wherein
each light element further comprises:
a light element information unit, configured to transmit identification information data uniquely identifying the light element and wireless address data of the light element by means of the wireless communication unit; and
the mounting pad further comprises:
a light element addressing unit, configured to receive the identification information data of the light element and the wireless address data of the light element from the light element information unit, so as to perform addressing on the light element.

7. The light system according to claim 6, wherein
that the wireless control unit is configured to transmit the light-emitting control signal to the wireless communication unit of the light element by means of wireless communication comprises:
according to a result that addressing is performed on the light element, transmitting each of the at least one light-emitting control signal to the wireless communication unit of the corresponding light element in the at least one light element.

8. The light system according to claim 7, wherein
the performing addressing on the light element further comprises determining position information of each of the at least one light element on the mounting surface of the mounting area of the mounting pad; and
the transmitting each of the at least one light-emitting control signal to the corresponding light element in the at least one light element further comprises determining a correspondence between the light element and the light-emitting control signal according to the characters or patterns of the at least one light element formed on the mounting surface and the position information of each light element.

9. The light system according to claim 6, wherein
the mounting pad further comprises:
a light-emitting control signal generation unit, configured to generate the light-emitting control signal for controlling the light-emitting mode of the light-emitting unit, and transmit the light-emitting control signal to the wireless control unit.

10. The light system according to claim 9, wherein
the mounting pad further comprises:
a command acquisition unit, configured to acquire a command used for generating the light-emitting control signal, and transmit the command to the light-emitting control signal generation unit, wherein
the light-emitting control signal generation unit generates the light-emitting control signal according to the command.

11. The light system according to claim 10, wherein
the command acquisition unit comprises:
an intelligent device communication unit, configured to acquire the command used for generating the light-emitting control signal from an intelligent device, wherein the command comprises data representing selection of the light-emitting mode for the at least one light element.

12. The light system according to claim 10, wherein
the command acquisition unit comprises:
a sensor, configured to acquire sensing data obtained by sensing environment information, wherein the environment information comprises at least one of light, temperature, or sound;
a feature extraction unit, configured to acquire the sensing data and extract feature data of the environment information; and
a command generation unit, configured to acquire the command used for generating the light-emitting control signal according to the feature data, wherein the command comprises data representing a correspondence between the feature data and the light-emitting mode of the at least one light element.

13. The light system according to claim 1, wherein
the attachment unit comprises at least one of a magnetic apparatus or a double-sided tape.

14. The light system according to claim 1, wherein
the wireless electric-power transmitting unit of the mounting pad comprises at least one wireless electric-power transmitting main coil disposed in the mounting area; and
the wireless electric-power receiving unit of the light element comprises at least one wireless electric-power receiving secondary coil.

15. The light system according to claim 1, wherein
the mounting pad further comprises:
an alternating-current receiving unit, configured to receive an alternating current; and
an AC-DC conversion unit, configured to convert the alternating current received by the alternating-current receiving unit into a direct current, and transmit the direct current to the wireless electric-power transmitting unit.

16. The light system according to claim 1, wherein
the light-emitting unit has at least one of the following a plurality of light-emitting modes:
emitting light with a single color;
emitting light with a plurality of colors; and
emitting light with changeable colors.

17. A light element, comprising:
a light-emitting unit, configured to emit light;
an attachment unit, configured to attach the light element to any position on a mounting surface on which the light element is mounted;
a wireless electric-power receiving unit, configured to receive electric power for driving the light element by means of wireless electric-power transmission; and
a light-emitting unit power supply circuit, connected to the wireless electric-power receiving unit and the light-emitting unit and configured to transmit the electric power received by the wireless electric-power receiving unit to the light-emitting unit.

18. The light element according to claim 17, wherein
at least one light element is mounted on the mounting surface so as to form characters or patterns.

19. The light element according to claim 18, wherein
the light element further comprises a light-emitting control unit, and the light-emitting control unit is configured to control the light-emitting unit to emit light according to a light-emitting control signal for controlling a light-emitting mode of the light-emitting unit.

20. The light element according to claim 19, wherein
the light-emitting control unit is configured to generate the light-emitting control signal for controlling the light-emitting mode of the light-emitting unit.

21. The light element according to claim 19, wherein
the light element further comprises:
a wireless communication unit, configured to receive the light-emitting control signal by means of wireless communication, and transmit the light-emitting control signal to the light-emitting control unit.

22. The light element according to claim 21, wherein
each light element further comprises:
a light element information unit, configured to transmit identification information data uniquely identifying the light element and wireless address data of the light element by means of the wireless communication unit.

23. The light element according to claim 17, wherein
the wireless electric-power receiving unit of the light element comprises at least one wireless electric-power receiving secondary coil.

24. The light element according to claim 17, wherein
the light element further comprises an electric-power storage unit, disposed between the wireless electric-power receiving unit and the light-emitting unit power supply circuit, and configured to store the electric power received by the wireless electric-power receiving unit and transmit the electric power to the light-emitting unit power supply circuit.

25. A mounting pad of a light, comprising:
a mounting area, provided with a mounting surface on which a light element is mounted; and
a wireless electric-power transmitting unit, configured to transmit electric power to the light element on the mounting surface by means of wireless electric-power transmission.

26. The mounting pad of a light according to claim 25, wherein
the mounting pad further comprises:
a wireless control unit, configured to transmit a light-emitting control signal for controlling a light-emitting mode to the light element by means of wireless communication.

27. The mounting pad of a light according to claim 26, wherein
the mounting pad further comprises:
a light element addressing unit, configured to receive identification information data of the light element and wireless address data of the light element from the light element, so as to perform addressing on the light element.

28. The mounting pad of a light according to claim 27, wherein
that the wireless control unit is configured to transmit the light-emitting control signal to the light element by means of wireless communication comprises:
according to a result that addressing is performed on the light element, transmitting each of the at least one light-emitting control signal to a wireless communication unit of the corresponding light element in the at least one light element.

29. The mounting pad of a light according to claim 28, wherein
the performing addressing on the light element further comprises determining position information of each of the at least one light element on the mounting surface of the mounting area of the mounting pad; and
the transmitting each of the at least one light-emitting control signal to the corresponding light element in the at least one light element further comprises determining a correspondence between the light element and the light-emitting control signal according to the characters or patterns of the at least one light element formed on the mounting surface and the position information of each light element.

30. The mounting pad of a light according to claim 27, wherein
the mounting pad further comprises:
a light-emitting control signal generation unit, configured to generate the light-emitting control signal for controlling the light-emitting mode of the light element, and transmit the light-emitting control signal to the wireless control unit.

31. The mounting pad of a light according to claim 30, wherein
the mounting pad further comprises:
a command acquisition unit, configured to acquire a command used for generating the light-emitting control signal, and transmit the command to the light-emitting control signal generation unit, wherein
the light-emitting control signal generation unit generates the light-emitting control signal according to the command.

32. The mounting pad of a light according to claim 31, wherein
the command acquisition unit comprises:
an intelligent device communication unit, configured to acquire the command used for generating the light-emitting control signal from an intelligent device, wherein the command comprises data representing selection of the light-emitting mode for the at least one light element.

33. The mounting pad of a light according to claim 31, wherein
the command acquisition unit comprises:
a sensor, configured to acquire sensing data obtained by sensing environment information, wherein the environment information comprises at least one of light, temperature, or sound;
a feature extraction unit, configured to acquire the sensing data and extract feature data of the environment information; and
a command generation unit, configured to acquire the command used for generating the light-emitting control signal according to the feature data, wherein the command comprises data representing a correspondence between the feature data and the light-emitting mode of the at least one light element.

34. The mounting pad of a light according to claim 25, wherein
the wireless electric-power transmitting unit of the mounting pad comprises at least one wireless electric-power transmitting main coil disposed in the mounting area.

35. The mounting pad of a light according to claim 25, wherein
the mounting pad further comprises:
an alternating-current receiving unit, configured to receive an alternating current; and
an AC-DC conversion unit, configured to convert the alternating current received by the alternating-current receiving unit into a direct current, and transmit the direct current to the wireless electric-power transmitting unit.

36. A light system, comprising at least one light element and a mounting pad, wherein
the light element comprises:
a light-emitting unit, configured to emit light;
an attachment unit, configured to attach the light element to any position on a mounting surface on which the light element is mounted; and
a light element information unit, configured to transmit identification information data uniquely identifying the light element and wireless address data of the light element; and
the mounting pad comprises:
a mounting area, provided with the mounting surface on which the light element is mounted; and
a light element addressing unit, configured to receive the identification information data of the light element and the wireless address data of the light element from the light element information unit, so as to perform addressing on the light element.

37. The light system according to claim 36, wherein
the at least one light element is mounted on the mounting surface so as to form characters or patterns.

38. The light system according to claim 37, wherein
the light element further comprises:
a wireless communication unit, configured to receive a light-emitting control signal by means of wireless communication; and
the mounting pad further comprises:
a wireless control unit, configured to transmit the light-emitting control signal to the wireless communication unit of the light element by means of wireless communication.

39. The light system according to claim 38, wherein
that the wireless control unit is configured to transmit the light-emitting control signal to the wireless communication unit of the light element by means of wireless communication comprises:
according to a result that addressing is performed on the light element, transmitting each of the at least one light-emitting control signal to the wireless communication unit of the corresponding light element in the at least one light element.

40. The light system according to claim 39, wherein
the performing addressing on the light element further comprises determining position information of each of the at least one light element on the mounting surface of the mounting area of the mounting pad; and
the transmitting each of the at least one light-emitting control signal to the corresponding light element in the at least one light element further comprises determining a correspondence between the light element and the light-emitting control signal according to the characters or patterns of the at least one light element formed on the mounting surface and the position information of each light element.

41. A light element, comprising:
a light-emitting unit, configured to emit light;
an attachment unit, configured to attach the light element to any position on a mounting surface on which the light element is mounted; and
a light element information unit, configured to transmit identification information data uniquely identifying the light element and wireless address data of the light element.

42. The light element according to claim 41, wherein
the light element further comprises:
a wireless communication unit (111), configured to receive a light-emitting control signal by means of wireless communication.

43. A mounting pad, comprising:
a mounting area, provided with a mounting surface on which a light element is mounted; and
a light element addressing unit, configured to receive identification information data of the light element and wireless address data of the light element from the light element, so as to perform addressing on the light element.

44. The mounting pad according to claim 43, wherein
the mounting pad further comprises:
a wireless control unit, configured to transmit a light-emitting control signal to the light element by means of wireless communication.

45. The mounting pad according to claim 44, wherein
that the wireless control unit is configured to transmit the light-emitting control signal to the light element by means of wireless communication comprises:
according to a result that addressing is performed on the light element, transmitting each of the at least one light-emitting control signal to a wireless communication unit of the corresponding light element in the at least one light element.

46. The mounting pad according to claim 45, wherein
the performing addressing on the light element further comprises determining position information of each of the at least one light element on the mounting surface of the mounting area of the mounting pad; and
the transmitting each of the at least one light-emitting control signal to the corresponding light element in the at least one light element further comprises determining a correspondence between the light element and the light-emitting control signal according to the characters or patterns of the at least one light element formed on the mounting surface and the position information of each light element.
